(19) United States
(12) Patent Application Publication
(10) Pub. No.: US 2025/0070911 A1
(43) Pub. Date: Feb. 27, 2025

(54) METHOD AND DEVICE FOR CONTROLLING INTER-CELL INTERFERENCE IN WIRELESS COMMUNICATION SYSTEM

(71) Applicant: SAMSUNG ELECTRONICS CO., LTD., Suwon-si (KR)

(72) Inventors: Soomin KO, Suwon-si (KR); Jeongchan KIM, Suwon-si (KR); Okyoung CHOI, Suwon-si (KR)

(21) Appl. No.: 18/941,444

(22) Filed: Nov. 8, 2024

Related U.S. Application Data
(63) Continuation of application No. PCT/KR2023/006380, filed on May 10, 2023.

(30) Foreign Application Priority Data
May 10, 2022 (KR) 10-2022-0057105
Jul. 8, 2022 (KR) 10-2022-0084445
Oct. 25, 2022 (KR) 10-2022-0138674

(51) Int. Cl. H04L 1/00

(52) U.S. Cl. CPC H04L 1/0009; H04L 1/0003

(57) ABSTRACT

The present disclosure relates to a 5G or 6G communication system for supporting higher data transmission rate. According to various embodiments, a method performed by a serving base station in a wireless communication system may comprise: receiving information about an aggregated slot from an aggregated slot managing device; aggregating, on the basis of the information about the aggregated slot, traffic to be transmitted during a specific interval into the aggregated slot and scheduling same; determining adaptive modulation and coding (AMC) parameters separately for an aggregated slot and a non-aggregated slot; and transmitting the traffic for the aggregated slot using the determined AMC parameters.

### CROSS-REFERENCE TO RELATED APPLICATIONS

This application is a continuation of International Application No. PCT/KR2023/006380 designating the United States, filed on May 10, 2023, in the Korean Intellectual Property Receiving Office and claiming priority to Korean Patent Application Nos. 10-2022-0057105, filed on May 10, 2022, 10-2022-0084445, filed on Jul. 8, 2022, and 10-2022-0138674, filed on Oct. 25, 2022, in the Korean Intellectual Property Office, the disclosures of each of which are incorporated by reference herein in their entireties.

### BACKGROUND

### Field

The disclosure relates to a wireless communication system and, for example, to a method and a device for controlling inter-cell interference in a wireless communication system.

### Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In a communication/broadcasting system, link performance may be significantly degraded by various types of noise, a fading phenomenon, and inter-symbol interference (ISI) of a channel. Therefore, in order to implement high-speed digital communication/broadcasting systems requiring high data throughput and reliability such as next-generation mobile communications, digital broadcasting, and portable Internet, it is required to develop a technology for overcoming noise, fading, and inter-symbol interface.

### SUMMARY

Embodiments of the disclosure provide a device and a method performed by a serving cell for controlling inter-cell interference in a wireless communication system.

According to various example embodiments of the disclosure, a method performed by a serving base station in a wireless communication system may include: receiving information on an aggregated slot from an aggregated slot management device, aggregating, based on the information on the aggregated slot, traffic to be transmitted during a specified interval into the aggregated slot and scheduling the aggregated traffic, determining separate adaptive modulation and coding (AMC) for the aggregated slot and a non-aggregated slot, and transmitting the traffic to a terminal in the aggregated slot using the determined AMC.

According to various example embodiments of the disclosure, a device of a serving base station in a wireless communication system may include: a transceiver and at least one processor, comprising processing circuitry, wherein at least one processor, individually and/or collectively, is configured to: receive information on an aggregated slot from an aggregated slot management device, aggregate, based on the information on the aggregated slot, traffic to be transmitted during a specified interval into the aggregated slot and schedule the aggregated traffic, determine separate adaptive modulation and coding (AMC) for the aggregated slot and a non-aggregated slot, and control the transceiver to transmit the traffic of the aggregated slot to a terminal using the determined AMC.

According to various example embodiments of the disclosure, a method performed by a neighboring base station in a wireless communication system may include: receiving information on an aggregated slot from an aggregated slot management device, aggregating, based on the information on the aggregated slot, traffic to be transmitted during a specified interval into the aggregated slot and scheduling the aggregated traffic, and transmitting the traffic to a terminal in the aggregated slot.

According to various example embodiments of the disclosure, a device of a neighboring base station in a wireless communication system may include: a transceiver and at least one processor, comprising processing circuitry, wherein at least one processor, individually and/or collectively, is configured to: receive information on an aggregated slot from an aggregated slot management device, aggregate, based on the information on the aggregated slot, traffic to be transmitted during a specified interval into the aggregated slot and schedule the aggregated traffic, and control the transceiver to transmit the traffic to a terminal in the aggregated slot.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example of a radio resource region in a wireless communication system according to various embodiments;

FIG. 2 is a diagram illustrating an example of radio resource allocation when an aggregated slot is configured according to various embodiments;

FIG. 3 is a diagram illustrating an example of radio resource allocation when an aggregated slot is configured according to various embodiments;

FIG. 4 is a diagram illustrating an example of radio resource allocation when an aggregated slot is configured according to various embodiments;

FIG. 5 is a table illustrating an example of radio resource allocation when an aggregated slot is configured according to various embodiments;

FIG. 6 is a diagram illustrating example buffer occupancy (BO) state of a base station when an aggregated slot is configured according to various embodiments;

FIG. 7 is a diagram illustrating example resource allocation according to various embodiments;

FIG. 8 includes tables illustrating an example of the number of code-blocks (CBs) and an RB per CB according to a modulation coding scheduling (MCS) level according to various embodiments;

FIG. 9 is a signal flow diagram illustrating example operations for inter-cell interference control between cells and an aggregated slot management device according to various embodiments;

FIG. 10 is a flowchart illustrating example operation of a serving base station according to various embodiments;

FIG. 11 is a flowchart illustrating example operation of an interfering base station according to various embodiments;

FIG. 12 is a graph illustrating a slot usage relative to a period of an aggregated slot according to various embodiments;

FIG. 13 is a graph illustrating a slot usage relative to a period of an aggregated slot according to various embodiments;

FIG. 14 is a graph illustrating data throughput relative to a signal to noise ratio (SNR) according to various embodiments; and

FIG. 15 is a block diagram illustrating an example configuration of a base station in a wireless communication system according to various embodiments.

With regard to the description of the drawings, the same or like reference signs may be used to designate the same or like elements.

### DETAILED DESCRIPTION

Various aspects of the disclosure described in greater detail with reference to the drawings, wherein like reference numerals are used to refer to like elements throughout. In the following description, for purposes of explanation, numerous specific details are set forth in order to provide a thorough understanding of one or more aspects. It may be apparent, however, that such aspect(s) may be practiced without these specific details.

The terms used in the disclosure are used merely to describe various example embodiments, and are not intended to limit the scope of the disclosure. A singular expression may include a plural expression unless they are definitely different in a context. The terms used herein, including technical and scientific terms, may have the same meaning as those commonly understood by one skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, terms defined in the disclosure should not be interpreted to exclude embodiments of the disclosure.

In the following description, terms referring to signals (e.g., message, signal, signaling, sequence, and stream), terms referring to resources (e.g., symbol, slot, subframe, radio frame, subcarrier, resource element (RE), resource block (RB), bandwidth part (BWP), and occasion), terms referring to operations (e.g., step, method, process, and procedure), terms referring to data (e.g., information, parameter, variable, value, bit, symbol, and codeword), terms referring to channels, terms referring to control information (e.g., downlink control information (DCI), media access control control element (MAC CE), and radio resource control (RRC) signaling), terms referring to network entities, terms referring to device elements, and the like are illustratively used for the sake of descriptive convenience. Therefore, the disclosure is not limited by the terms as used below, and other terms having equivalent technical meanings may be used.

Various aspects are described herein in connection with a wireless terminal and/or a base station. A wireless terminal may refer to a device providing voice and/or data connectivity to a user. A wireless terminal may be connected to a computing device such as a laptop computer or desktop computer, or it can be a self-contained device such as a personal digital assistant (PDA). A wireless terminal may also be referred to as a system, a subscriber unit, a subscriber station, a mobile station, a mobile, a mobile device, a remote station, a remote terminal, an access terminal, a user terminal, a terminal, a wireless communication device, a user agent, a user device, or user equipment. A wireless terminal may be a subscriber station, a wireless device, a cellular telephone, a PCS telephone, a cordless telephone, a session initiation protocol (SIP) phone, a wireless local loop (WLL) station, a personal digital assistant (PDA), a handheld device having wireless connection capability, or other processing device connected to a wireless modem. A base station (e.g., access point) may refer to a device in an access network that communicates over the air-interface, through one or more sectors, with wireless terminals. The base station may act as a router between the wireless terminal and the rest of the access network, which can include an Internet Protocol (IP) network, by converting received air-interface frames to IP packets. The base station also coordinates management of attributes for the air interface.

When two base stations are placed adjacent to each other and the coverage of the two base stations partially overlaps, a strong downlink (DL) signal from one base station may cause interference to a terminal served by the other base station. That is, inter-cell interference (ICI) may occur between a serving cell formed by base stations and an interfering cell adjacent to the serving cell to cause interference.

Unlike an LTE system, an NR system is designed based on the Ultra-Lean principle to minimize and/or reduce Always-On transmission, and thus if there is no actual data to be transmitted, interference may not occur with a neighboring cell. Therefore, control of ICI in the 5G NR system is receiving attention as one of the representative technologies for improving network performance.

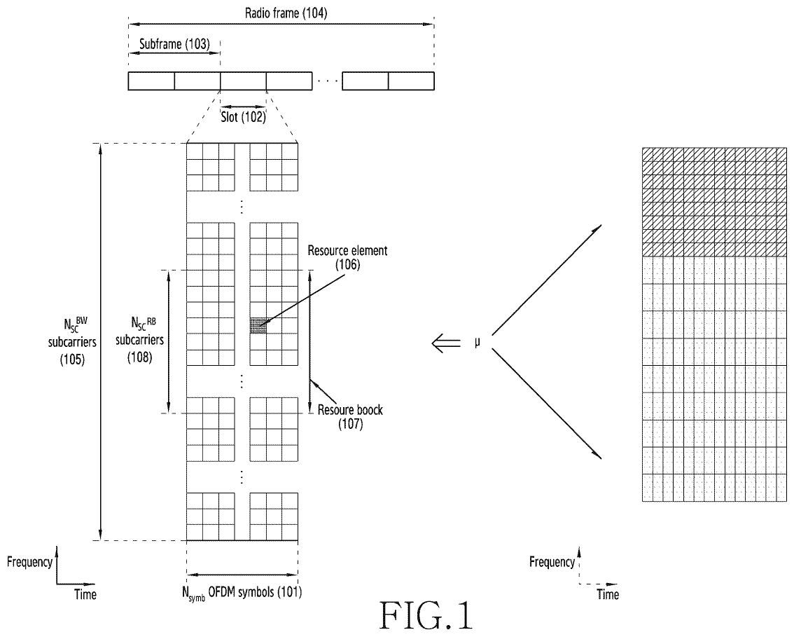

FIG. 1 is a diagram illustrating an example of a radio resource region in a wireless communication system according to various embodiments.

In various embodiments of the disclosure, a radio resource region may include a structure of a time-frequency domain. According to an embodiment, a wireless communication system may include an NR communication system.

Referring to FIG. 1, in the radio resource region, the horizontal axis indicates a time domain, and the vertical axis indicates a frequency domain. The length of a radio frame 104 is 10 ms. The radio frame 104 may be a time domain interval configured by 10 subframes. The length of a subframe 103 is 1 ms. The unit of configuration in the time domain may be an orthogonal frequency division multiplexing (OFDM) and/or a DFT-s-OFDM (discrete Fourier transform (DFT)-spread-OFDM) symbol, and Nsymb OFDM symbols and/or DFT-s-OFDM symbols 101 may be aggregated to configure one slot 102. In various embodiments, an OFDM symbol may include a symbol for a case of transmitting and receiving a signal using an OFDM multiplexing scheme, and a DFT-s-OFDM symbol may include a symbol for a case of transmitting and receiving a signal using a DFT-s-OFDM or single carrier frequency division multiple access (SC-FDMA) multiplexing scheme. The minimum transmission unit in the frequency domain is a subcarrier, and a carrier bandwidth configuring a resource grid may be configured by a total of NscBW subcarriers 105. In addition, in the disclosure, an embodiment regarding downlink signal transmission and reception is described for convenience of description, but this is also applicable to an embodiment regarding uplink signal transmission and reception.

In various embodiments, the number of slots 102 configuring one subframe 103 and the length of a slot 102 may vary depending on a subcarrier spacing. Such a subcarrier spacing may be referred to as numerology (μ). That is, a subcarrier spacing, the number of slots included in a subframe, the length of a slot, and the length of a subframe may be variably configured. For example, in an NR communication system, when a subcarrier spacing (SCS) is 15 kHz, one slot 102 may configure one subframe 103, and each of the lengths of the slot 102 and the subframe 103 may be 1 ms. In addition, for example, if the subcarrier spacing is 30 kHz, two slots may configure one subframe 103. In this case, the length of the slot is 0.5 ms and the length of the subframe is 1 ms.

In various embodiments, a subcarrier spacing, the number of slots included in a subframe, the length of a slot, and the length of the subframe may be variably applied depending on a communication system. For example, in the case of the LTE system, a subcarrier spacing is 15 kHz, two slots configure one subframe, and in this case, the length of a slot may be 0.5 ms and the length of the subframe may be 1 ms. For another example, in the case of the NR system, a subcarrier spacing (μ) may be one of 15 kHz, 30 kHz, 60 kHz, 120 kHz, and 240 kHz, and the number of slots included in one subframe according to the subcarrier spacing (μ) may be 1, 2, 4, 8, and 16.

The basic unit of a resource in the time-frequency domain may be a resource element (RE) 106, and the resource element 106 may be expressed as an OFDM symbol index and a subcarrier index. A resource block may include multiple resource elements. In the NR system, a resource block (RB) (or a physical resource block (PRB)) 107 may be defined as N_{SC}_{^{RB}} consecutive subcarriers 108 in the frequency domain. The number of subcarriers may be N_{SC}_{^{RB}}=12. The frequency domain may include common resource blocks (CRBs). A physical resource block (PRB) may be defined in a bandwidth part (BWP) on the frequency domain. CRB and PRB numbers may be determined differently depending on a subcarrier spacing. In the LTE system, an RB may be defined as Nsymb consecutive OFDM symbols in the time domain and N_{SC}_{^{RB}} consecutive subcarriers in the frequency domain.

In the NR and/or LTE system, scheduling information for downlink data or uplink data may be transmitted from a base station to a UE via downlink control information (DCI). In various embodiments, the DCI may be defined according to various formats, and each format may indicate whether the DCI includes scheduling information (e.g., UL grant) for uplink data, whether the DCI includes scheduling information (DL resource allocation) for downlink data, whether the DCI is compact DCI having a small size of control information, whether the DCI is fallback DCI, whether spatial multiplexing using multiple antennas is applied, and/or whether the DCI is DCI for power control. For example, NR DCI format 1_0 or NR DCI format 1_1 may include scheduling for downlink data. In addition, for example, NR DCI format 0_0 or NR DCI format 0_1 may include scheduling for uplink data.

As described above, FIG. 1 illustrates an example of a downlink and uplink slot structure in a wireless communication system. For example, FIG. 1 illustrates a structure of a resource grid of a 3GPP NR system. Referring to FIG. 1, a slot may include multiple orthogonal frequency division multiplexing (OFDM) symbols in the time domain and include multiple resource blocks (RBs) in the frequency domain. A signal may be configured by a part or the entirety of the resource grid. In addition, the number of OFDM symbols included in one slot may generally vary depending on the length of a cyclic prefix (CP). In FIG. 1, for convenience of description, the case in which one slot is configured by 14 OFDM symbols is illustrated, but in the case of the signal referred to in the disclosure, the configuration of symbols is not specified. In addition, a modulation scheme of a generated signal is not limited to a specific value of quadrature amplitude modulation (QAM), and may follow modulation schemes of various communication standards such as binary phase-shift keying (BPSK) and quadrature phase shift keying (QPSK).

Although various embodiments of the disclosure are described based on the LTE communication system or the NR communication system, the content of the disclosure is not limited thereto and may be applied in various wireless communication systems for transmitting downlink or uplink control information. In addition, it is apparent that the content of the disclosure may be applied, as needed, in an unlicensed band in addition to a licensed band.

In the following description, higher layer signaling may be performed or a higher signal may be transmitted by a signal transmission method in which a base station transmits a signal to a user equipment (UE) using a downlink data channel of a physical layer, or the UE transmits a signal to the base station using an uplink data channel of the physical layer. According to an embodiment, the higher layer signaling may include at least one of radio resource control (RRC) signaling, signaling according to an F1 interface between a centralized unit (CU) and a distributed unit (DU), or a method of transmitting a signal through a media access control (MAC) control element (MAC CE). In addition, according to an embodiment, the higher layer signaling or higher signal may include system information that is commonly transmitted to multiple UEs, such as a system information block (SIB).

In a 5G wireless communication system, a synchronization signal block (SSB) (or referred to as an SS block, an SS/PBCH block, etc.) may be transmitted for initial access, and the synchronization signal block may be configured by a primary synchronization signal (PSS), a secondary synchronization, signal (SSS), and a physical broadcast channel (PBCH). In an initial access step in which a UE first accesses the system, the UE may obtain downlink time and frequency domain synchronization from a synchronization signal and obtain a cell ID, through a cell search procedure. The synchronization signal may include a PSS and an SSS. The UE may receive a PBCH including a master information block (MIB) from a base station to obtain a basic parameter value and system information related to transmission and reception, such as a system bandwidth or related control information. The UE may obtain a system information block (SIB) by performing decoding on a physical downlink control channel (PDCCH) and a physical downlink shared channel (PDSCH), based on the received PBCH. The UE may exchange identity with the base station through a random access step and may initially access a network through steps such as registration and authentication.

As described above, one slot may include 14 symbols, and in the 5G communication system, uplink-downlink configuration of a symbol and/or a slot may be configured in, for example, three steps.

In a first method, an uplink-downlink of a symbol and/or a slot may be semi-statically configured through cell-specific configuration information through system information in the unit of a symbol. For example, the cell-specific uplink-downlink configuration information through the system information may include uplink-downlink pattern information and reference subcarrier information. The uplink-downlink pattern information may indicate a pattern periodicity, the number of consecutive downlink slots from a start point of each pattern, the number of symbols in the next slot, the number of consecutive uplink slots from the end of a pattern, and the number of symbols in the next slot. A slot and a symbol which are not indicated as an uplink and a downlink may be determined as a flexible slot/symbol.

In a second method, through user-specific configuration information via dedicated higher layer signaling, a flexible slot or a slot including a flexible symbol may be indicated by the number of consecutive downlink symbols from a start symbol of each slot and the number of consecutive uplink symbols from the end of a slot, or indicated as a downlink or uplink of the entire slot.

In a third method, in order to dynamically change downlink signal transmission and uplink signal transmission intervals, symbols (e.g., symbols not indicated as a downlink and an uplink) indicated as flexible symbols in each slot may be indicated as downlink symbols, uplink symbols, or flexible symbols, respectively, through a slot format indicator (SFI) included in a downlink control channel. The slot format indicator may select one index from a table (e.g., 3GPP TS 38.213 Table 11.1.1-1) in which an uplink-downlink configuration of 14 symbols in one slot are preconfigured.

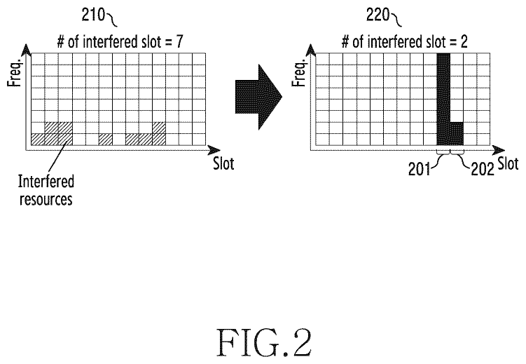

FIG. 2 is a diagram illustrating an example of radio resource allocation when an aggregated slot is configured according to various embodiments.

Referring to FIG. 2, the horizontal axis indicates a time domain, and the vertical axis indicates a frequency domain. The unit of division in the time domain may be a slot, and the unit of division in the frequency domain may be a subcarrier.

Among radio resources allocated in a serving cell, there is a radio resource (interfered resource) that may be interfered with by traffic of a neighboring cell. The traffic that is interfered with by the neighboring cell (that is, traffic of a neighboring cell that acts as interference to the serving cell) may be dispersed and may exist across multiple slots. Referring to FIG. 2, in a conventional case 210, radio resources that are interfered with by traffic of a neighboring cell may be distributed across a total of 7 slots with reference to the time axis.

According to an embodiment of the disclosure, in order to control inter-cell interference, a specific slot in the time domain to which traffic of a neighboring cell is to be aggregated and allocated may be configured. The specific slot in the time domain may be referred to as an aggregated slot or an interference aggregated slot. When an aggregated slot is configured, traffic transmitted in a predetermined (e.g., specified) interval may be aggregated and allocated to the aggregated slot.

An aggregated slot management device may preconfigure an aggregated slot and transmit information on the aggregated slot to the entire cell. Accordingly, positions of aggregated slots of cells managed by the aggregated slot management device may be aligned identically. For example, an aggregated slot for each cell may include the same operation interval and offset configuration.

According to an embodiment of the disclosure, radio resources to which traffic of a cell is allocated may be aggregated into a preconfigured aggregated slot and scheduled. Referring to FIG. 2, in a case where an aggregated slot is configured 220, radio resources to which traffic of a cell is allocated may be distributed across a total of two slots 201 and 202 with reference to the time axis. In this case, the frequency of a slot to which nothing is allocated, that is, a slot to which traffic is not allocated, may be increased.

According to an embodiment of the disclosure, when an aggregated slot is configured, a slot acting as interference may form a larger RB than before. However, in the NR system, even when decoding of only one code-block (CB) fails, the entire transport block (TB) including a CB may be treated as a transmission failure, and thus the size of an RB may have a less impact on throughput of data transmission. Therefore, even when the size of the RB acting as interference increases by configuring an aggregated slot, the adverse impact on the throughput of data transmission is small, and rather, the number of slots acting as interference is reduced and thus the total amount of interference is reduced, thereby improving the performance of data transmission.

According to an embodiment of the disclosure, when an aggregated slot is configured, the probability of inter-cell interference of a neighboring cell in the aggregated slot increases, but the probability of inter-cell interference of a neighboring cell in other slots (hereinafter, non-aggregated slots) decreases, and thus it is possible to distinguish between a time zone with a high probability of occurrence of inter-cell interference and a time zone with a low probability of occurrence of inter-cell interference.

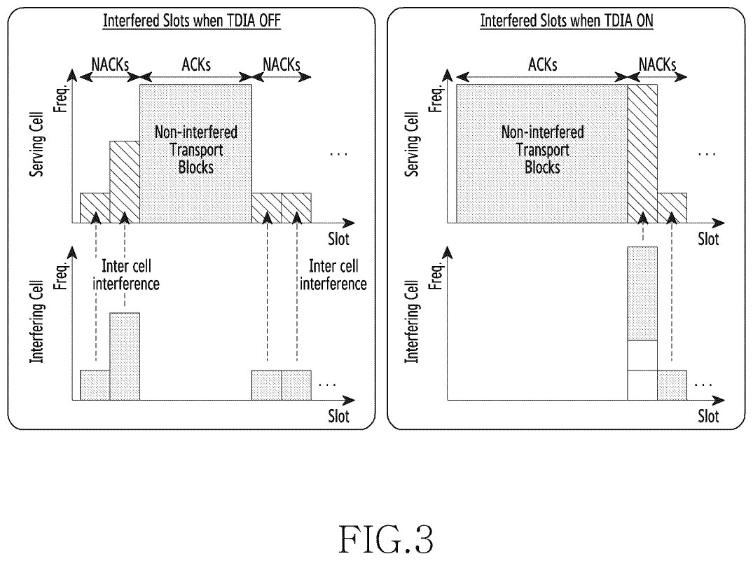

FIG. 3 is a diagram illustrating an example of radio resource allocation when an aggregated slot is configured according to various embodiments.

Referring to FIG. 3, the horizontal axis of a graph indicates a time domain, and the vertical axis indicates a frequency domain. The unit of division in the time domain may be a slot, and the unit of division in the frequency domain may be a subcarrier.

According to an embodiment of the disclosure, an aggregated slot management device may aggregate traffic of a cell and configure the traffic to be allocated to a specific slot in the time domain. In this case, the specific slot in the time domain may be referred to as an aggregated slot. Cells managed by the aggregated slot management device may aggregate and allocate traffic of the cells to the aggregated slot, based on information on such an aggregated slot. An operation of configuring an aggregated slot to control inter-cell interference in the time domain by the aggregated slot management device may be referred to as time domain interference slot alignment (TDIA).

The aggregated slot management device may preconfigure and transmit information on the aggregated slot to the entire cell. Accordingly, positions of aggregated slots of cells managed by the aggregated slot management device may be aligned identically. For example, an aggregated slot for each cell may include the same operation interval and offset configuration.

Referring to FIG. 3, when an aggregated slot is not configured, randomly distributed traffic from a neighboring cell that is adjacent to a serving cell to cause inter-cell interference may affect the serving cell. The serving cell may be affected by interference according to a slot in which traffic within the neighboring cell is distributed. On the other hand, when an aggregated slot is configured, traffic of a cell may be aggregated and allocated to the aggregated slot of the cell. When traffic of a neighboring cell that acts as interference to the aggregated slot is aggregated and allocated, an interval of a non-aggregated slot to which traffic acting as interference to the cell is allocated may be longer. The non-aggregated slot may refer to a slot other than a configured aggregated slot, and may be a slot having a low possibility of occurrence of inter-cell interference.

For example, when TDIA operates, the serving cell may transmit more slots in which there is traffic that does not act as interference to a UE than when TDIA does not operate, and accordingly, the serving cell may obtain an effect that is less affected by inter-cell interference of an interfering cell.

According to an embodiment of the disclosure, when an aggregated slot is configured, the probability of inter-cell interference of a neighboring cell in the aggregated slot increases, but the probability of inter-cell interference of a neighboring cell in other slots (hereinafter, non-aggregated slots) may decrease. On the other hand, when an aggregated slot is not configured, the probability of occurrence of inter-cell interference of a neighboring cell may occur randomly for each slot.

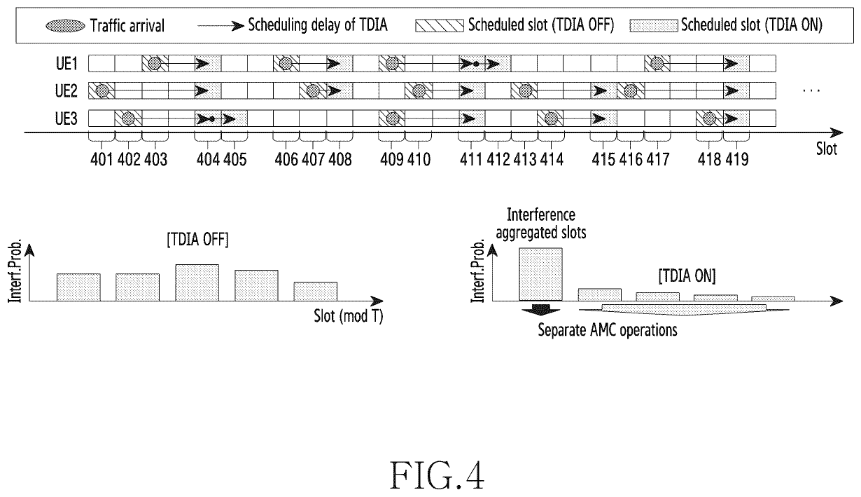

FIG. 4 is a diagram illustrating an example of radio resource allocation when an aggregated slot is configured according to various embodiments.

According to an embodiment of the disclosure, when an aggregated slot is configured, a cell may schedule traffic to be transmitted in a predetermined interval to the configured aggregated slot. More specifically, when traffic occurs, the cell may wait without transmitting the traffic until the configured aggregated slot is reached. Since such traffic may act as interference to a neighboring cell, the traffic may be aggregated and allocated to the aggregated slot and transmitted to a UE. That is, the traffic may be delayed in transmission until the aggregated slot is reached, and may not be transmitted to the UE.

Additionally, when no more traffic may be allocated to the aggregated slot, the traffic may be allocated to the next slot of the aggregated slot. In this case, the next slot of the aggregated slot may be a non-aggregated slot.

Referring to FIG. 4, when an aggregated slot is not configured and traffic is transmitted, traffic of a cell is transmitted to UE 1 to UE 3, and the number of aggregated slots to which the traffic of the cell is allocated may be 12 (401, 402, 403, 406, 407, 409, 410, 413, 414, and 416, 417 and 418). On the other hand, when an aggregated slot is configured and traffic is aggregated into the aggregated slot and transmitted, the number of aggregated slots may be reduced to 7 (404, 405, 408, 411, 412, 415, and 419) compared to the number of aggregated slots when the aggregated slot is not configured.

According to an embodiment of the disclosure, when a heavy traffic UE exists in a serving cell and a light traffic UE exists in an interfering cell, traffic of both the serving cell and the interfering cell may be aggregated and allocated to an aggregated slot. In this case, traffic exceeding the traffic allocated to the aggregated slot of the interfering cell of the serving cell may be less affected by inter-cell interference due to the traffic of the interfering cell. For example, referring to FIG. 4, when UE 3 exists in the serving cell and UE 1 or UE 2 exists in the interfering cell, the traffic of both the serving cell and the interfering cell may be aggregated into the aggregated slots 404 and 405. In this case, traffic of UE 3 allocated to the slot 405, which exceeds the traffic allocated to the aggregated slot 404 of UE 1 or UE 2, may not be affected by interference. Accordingly, UE 3 located in the serving cell may obtain a performance gain as much as the traffic of the slot 405 that is not affected by interference.

Referring to FIG. 4, when an aggregated slot is not configured and traffic is transmitted, the probability of occurrence of inter-cell interference per slot exists randomly for each slot, but when traffic is aggregated into the aggregated slot and transmitted, the probability of occurrence of inter-cell interference of a neighboring cell in the aggregated slot is high and the probability of inter-cell interference of a neighboring cell in a non-aggregated slot is low, and thus it is possible to distinguish between a time zone with a high probability of occurrence of inter-cell interference and a time zone with a low probability of occurrence of inter-cell interference. In addition, even when the size of an RB of interference is larger, the decoding performance of a CB may not be significantly affected. That is, even when the size of an RB acting as interference increases by configuring an aggregated slot, the adverse impact on throughput of data transmission is small, and rather, the number of slots acting as interference is reduced and thus the total amount of interference is reduced, thereby improving the performance of data transmission.

According to an embodiment of the disclosure, since the probability of occurrence of inter-cell interference is high in an aggregated slot, separate adaptive modulation and coding (AMC) may be determined for each of the aggregated slot and a slot other than the aggregated slot (hereinafter, a non-aggregated slot).

A maximum expected value for downlink data throughput from a cell to a UE is as shown in <equation 1> below.

$${max}_{{r}_{1} , {r}_{2} , a} [ a {r}_{1} {p}_{1} ( {r}_{1} ) + ( 1 - a ) {r}_{2} {p}_{2} ( {r}_{2} ) ] \qquad [ Equation 1 ]$$

$$s . t . {ap}_{1} ( {r}_{1} ) + ( 1 - a ) {p}_{2} ( {r}_{2} ) \geq {p}_{t}$$

p₁ and p₂ may refer to data transmission probabilities in the case of no inter-cell interference, and r₁ and r₂ may refer to TBSs to which an AMC determination in the case of no inter-cell interference is applied. a may refer to the probability of occurrence of inter-cell interference. pₜ may refer to the target probability of successful transmission and may be defined as pₜ=1−target block error rate (BLER).

In general, it may be difficult to know whether there is inter-cell interference in each time zone in a wireless communication system. Therefore, the same AMC determination is applied regardless of whether there is inter-cell interference. In this case, <Equation 1> may be expressed as the following <Equation 2>.

$${max}_{r} [ rp ( r ) ] \qquad [ Equation 2 ]$$

$$s . t . p ( r ) \geq {p}_{t}$$

r may refer to a value that replaces rₙ, and p may indicate p=ap₁+(1−a)p₂. In order to determine the maximum data throughput, information on successful transmission probability p may be required. However, it may be difficult to determine the information on p due to inter-cell interference and the mobility of a radio resource. Therefore, the maximum data throughput may be determined by reducing the probability a of occurrence of inter-cell interference.

According to an embodiment of the disclosure, when a separate AMC determination is applied to an aggregated slot and a non-aggregated slot to which traffic of a neighboring cell that acts as interference is aggregated and allocated, the probability of occurrence of inter-cell interference may be indirectly reduced.

If the past transmission in the aggregated slot is an ACK, a base station may increase a signal to interference noise ratio (SINR) of the aggregated slot, and if the past transmission in the aggregated slot is a NACK, may decrease the SINR. If the past transmission in the non-aggregated slot is an ACK, the base station may increase an SINR of the non-aggregated slot, and if the past transmission in the non-aggregated slot is a NACK, may decrease the SINR. The SINR may be increased by increasing the strength of a reception signal of an uplink.

An adaptive modulation and coding selection (MCS) level is selected according to a signal SINR ratio of a channel through which data is transmitted and received. A low MCS level is applied to the aggregated slot, and a high MCS level is applied to the non-aggregated slot, so that a low data transmission rate may be applied to the aggregated slot in which the frequency of occurrence of inter-cell interference is expected to be high.

The detailed operation of configuring an aggregated slot to aggregate and allocate traffic of a neighboring cell that acts as interference, and applying a separate AMC determination to the aggregated slot and a non-aggregated slot may be expressed by algorithm in <Table 1> below.

TABLE 1

| Input: TDIA period T, UE set K , CSI/HARQ feedback | |
|---|---|
| Output: data rate for IA or non-IA slot (rₙ(k)) | |
| 1: | procedure TDIA-AMC |
| 2: | for each time t |
| 3: | if (t == 0) then |
| 4: | for all k ∈ K do |
| 5: | initialize offsetₙ(k) = 0,∀n ∈ (1,2) |
| 6: | end for |
| 7: | end if |
| 8: | if (mod(t,T) == 0) then // IA slot |
| 9: | set n = 1 |
| 10: | else // non-IA slot |
| 11: | set n = 2 |
| 12: | end |
| 13: | for all k ∈ K do |
| 14: | if UE(^{k})'s CSI feedback is received then |
| 15: | set CQI = received CQI |
| 16: | set RI = received RI |
| 17: | set SINR(k) = CSItoSINR(CQI,RI) |
| 18: | end if |
| 19: | if UE(^{k})'s HARQ feedback is received then |
| 20: | set τ = UE(^{k})'s HARQ feedback delay |
| 21: | if (mod(t − τ,T) == 0) then // IA slot |
| 22: | set m = 1 |
| 23: | else // non-IA slot |
| 24: | set m = 2 |
| 25: | end if |
| 26: | if HARQ feedback == ACK then |
| 27: | offsetₘ(k) += Δ(1 − p_{t,m}) |
| 28: | else // NACK |
| 29: | offsetₘ(k) −= Δ(p_{t,m}) |
| 30: | end if |
| 31: | end if |
| 32: | set SINRₙ(k) = SINR(k) + offsetₙ(k) |
| 33: | set rₙ(k) = SINRtoDataRate(SINRₙ(k)) |
| 34: | end for |
| 35: | end for |
| 36: | end procedure |

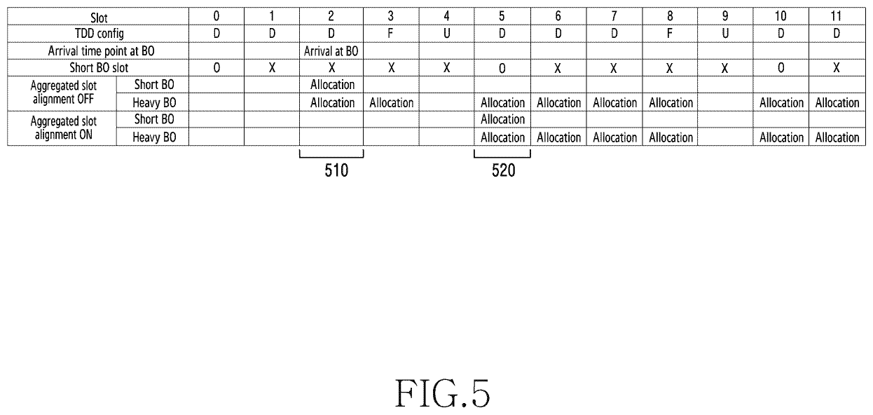

FIG. 5 is a table illustrating example radio resource allocation when an aggregated slot is configured according to various embodiments.

Referring to FIG. 5, traffic allocation in slot indexes 0 to 11 is illustrated. Traffic may occur in a buffer occupancy (BO) of a base station in slot index 2 510. When an aggregated slot is not configured, the base station may allocate traffic acting as interference to slot indexes 2, 3, 5 to 8, 10, and 11 by combining a short BO and a heavy BO and transmit the traffic to a UE. For example, when the aggregated slot is not configured, the traffic acting as interference is randomly allocated, and a total of 8 slots (slot indexes 2, 3, 5 to 8, 10, and 11) may be affected by interference.

On the other hand, when an aggregated slot is configured, traffic acting as interference may be aggregated and allocated to the aggregated slot. For example, referring to FIG. 5, the aggregated slot is configured as slot index 5 520. In the case of the short BO, the base station may allocate and transmit traffic in slot index 5 520 without transmitting, to the UE, the traffic in slot index 2 510 where the traffic has arrived at a BO. In addition, in the case of the heavy BO, the base station may allocate traffic in slot index 5 520 without transmitting the traffic in slot index 2 510 where the traffic has arrived at a BO to the UE, and when the traffic exceeds an allocated radio resource, excess traffic may be allocated to a slot after slot index 5 520 for the excess traffic. For example, when the aggregated slot is configured, traffic acting as interference is aggregated and allocated to the aggregated slot, and a total of 6 slots (slot indexes 5 to 8, 10, and 11) may be affected by interference.

For example, compared to when an aggregated slot is not configured, when an aggregated slot is configured and traffic is aggregated, sorted, and allocated to the aggregated slot, the number of slots to which traffic that causes interference is allocated may be reduced. Accordingly, the probability of occurrence of interference is reduced, and the data communication performance of the network may be improved.

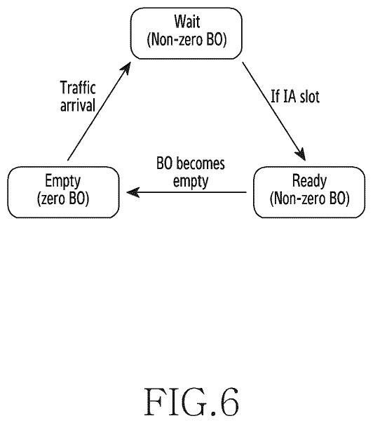

FIG. 6 is a diagram illustrating a buffer occupancy (BO) state of a base station when an aggregated slot is configured according to various embodiments. For example, FIG. 6 illustrates a BO state of a base station when a TDIA operation is performed.

Referring to FIG. 6, when a buffer occupancy (BO) of a base station is empty, this may be referred to as an empty state. If traffic occurs in the BO of the base station in the empty state, a state of the BO of the base station may indicate that the BO of the base station is filled with the traffic that has occurred (Non-zero BO). In this case, the BO state of the base station may be referred to as a wait state. In this case, the BO of the base station may maintain the wait state without transmitting traffic to a UE until the traffic arrives at an aggregated slot.

When the traffic having occurred in the BO of the base station arrives at the aggregated slot, the state of the BO may be changed to a ready state. In this case, the traffic having arrived at the aggregated slot may be transmitted to the UE. Even when additional traffic occurs thereafter, the traffic is allocated to the aggregated slot and transmitted to the UE, and thus the ready state may be maintained. The detailed operation of the TDIA operation may be expressed by algorithm in <Table 2> below.

TABLE 2
Input: TDIA period T, UE set K
Output: decision on data transmission for each UE at each time slot

| | |
|---|---|
| 1: | procedure TDIA |
| 2: | for each time slot ^{t} |
| 3: | if (t == 0) then |
| 4: | for all k ∈ K do |
| 5: | initialize UE(^{k}).state = “Empty” |
| 6: | end for |
| 7: | end if |
| 8: | if (mod(t,T) == 0)) then // IA slot |
| 9: | AMC policy for IA slot will be applied |
| 10: | else // non-IA slot |
| 11: | AMC policy for non-IA slot will be applied |
| 12: | end if |
| 13: | for all k ∈ K do |
| 14: | if (UE(^{k})'s traffic is arrived) then |
| 15: | if (UE(^{k}).state == “Empty”) then |
| 16: | set UE^{(k}).state = “Wait” |
| 17: | end if |
| 18: | end if |
| 19: | if (mod(t,T) == 0)) then // IA slot |
| 20: | if (UE(^{k}).state == “Wait”) then |
| 21: | set UE^{(k}).state = “Ready” |
| 22: | end if |
| 23: | end |
| 24: | if (UE(^{k}).state == “Ready”) then |
| 25: | transmission for UE(^{k}) is allowed |
| 26: | else |
| 27: | transmission for UE(k) is not allowed |
| 28: | end |
| 29: | if (UE(^{k})'s BO becomes empty) then |
| 30: | set UE^{(k}).state = “Empty” |
| 31: | end if |
| 32: | end for |
| 33: | end for |
| 34: | end procedure |

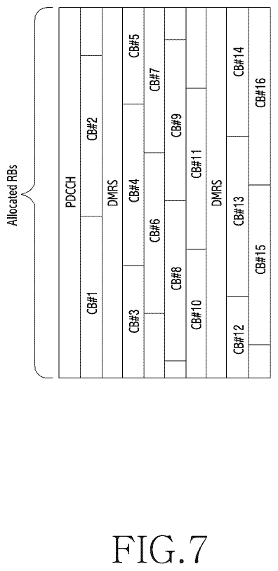

FIG. 7 is a diagram illustrating example resource allocation according to various embodiments.

Referring to FIG. 7, the horizontal axis indicates a frequency domain, and the vertical axis indicates a time domain.

In the NR system, one transport block (hereinafter, referred to as a TB) may include multiple code blocks (hereinafter, referred to as CBs). A cyclic redundancy check (CRC) (not shown) may be added to the rear end or front end of one TB desired to be transmitted in an uplink or a downlink. The CRC may have 16 bits or 24 bits or a fixed number of bits, or have a variable number of bits according to a channel condition, and may be used to determine whether channel coding is successful. In the NR system, a TB may be configured by multiple CBs without a separate division process. Even when a CRC failure occurs in only one CB, a NACK determination that transmission has failed for the entire TB may be made.

The larger the size of a transport block (TB size, TBS), the greater the number of CBs may become. Accordingly, the number of resource blocks that may be occupied per transmission block may be reduced. As the TBS increases, it may be vulnerable to interference from a small number of RBs. That is, as the TBS increases, even when a CRC failure occurs in one of the multiple CBs included in the TB due to interference, the entire TB may be affected by interference. For example, as in FIG. 7, when a CRC failure occurs in at least one CB among CB #3 to CB #5 configuring one TB, a NACK determination that transmission has failed for the corresponding TB may be made.

According to an embodiment of the disclosure, as the TBS increases, it is vulnerable to interference from an RB, and thus the aggregating of traffic of a neighboring cell that acts as interference in a specific aggregated slot during a predetermined period of time may have a less impact from interference compared to when traffic of a neighboring cell that acts as interference is distributed across multiple slots. That is, even when the size of an RB acting as interference increases, if traffic of a neighboring cell acting as interference is aggregated and allocated to an aggregated slot, the size of the RB acting as interference increases, but the difference in performance may not be significant in that the entire TB to which a corresponding CB belongs is affected by interference regardless of the size of the RB.

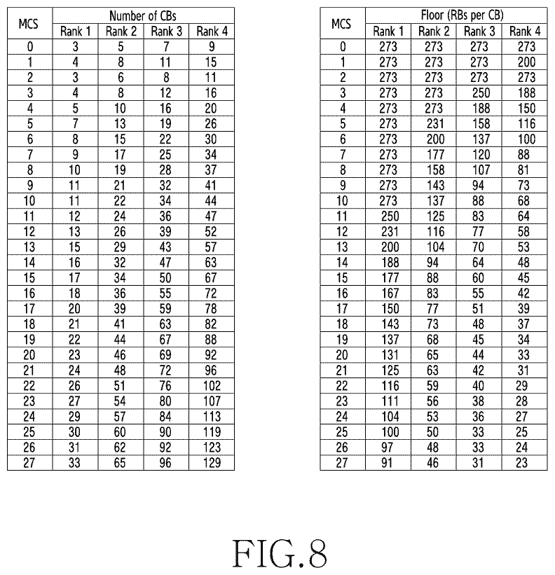

FIG. 8 includes tables illustrating examples of the number of code-blocks (CBs) and an RB per CB according to a modulation coding scheduling (MCS) level according to various embodiments.

According to FIG. 8, the number of CBs that may exist may be determined according to a level of a Rank indicating the number of transmission layers and an MCS level. For example, in the case of MCS 27 and Rank 4, the number of CBs may be 129. In addition, according to FIG. 8, an RB occupied per CB may be determined. For example, in the case of MCS 27 and Rank 4, 23 RBs may be occupied per CB. According to an embodiment of the disclosure, in the case of MCS 27 and Rank 4 in FIG. 8, when the size of traffic of a neighboring cell that acts as interference exceeds 23 RBs, as long as interference exceeding one CB configuring a TB occurs, a NACK determination may be made for the entire TB including the corresponding CB as if interference has occurred. For example, when interference exceeding the size of an RB occupied per CB occurs, even when the RB size of the interference is larger, the decoding performance of a CB may not be significantly affected. For example, even when the size of an RB acting as interference increases by configuring an aggregated slot, the adverse impact on throughput of data transmission is small, and rather, the number of slots acting as interference is reduced and thus the total amount of interference is reduced, thereby improving the performance of data transmission.

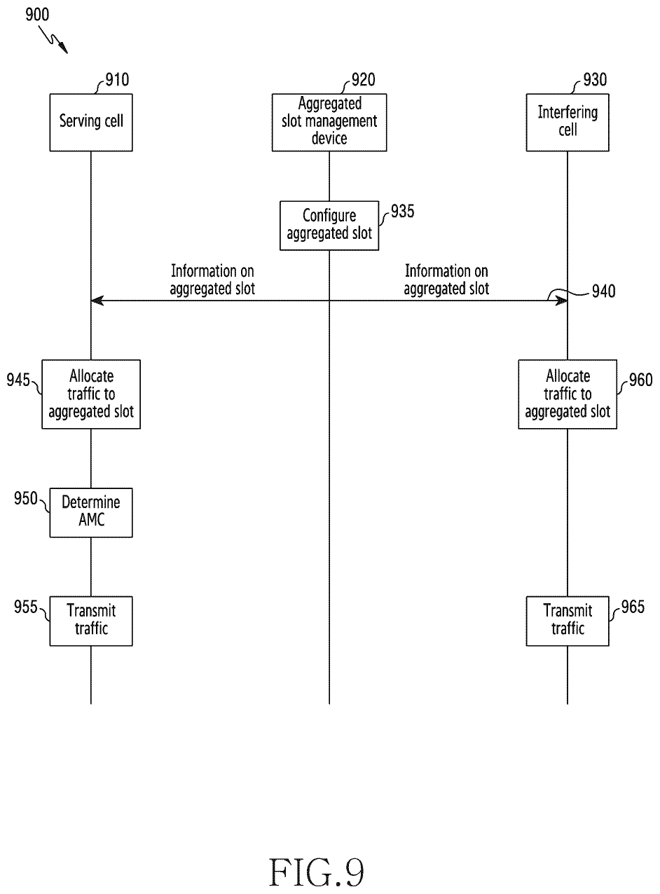

FIG. 9 is a signal flow diagram 900 illustrating example operations between cells and an aggregated slot management device according to various embodiments.

Referring to FIG. 9, an aggregated slot management device 920 may configure a specific slot in a time domain for aggregating traffic of a cell in order to control inter-cell interference (935). The specific slot in the time domain may be referred to as an interference aggregated slot or an aggregated slot. When an aggregated slot is configured, traffic transmitted in a predetermined interval may be aggregated and allocated to the aggregated slot.

The aggregated slot management device 920 may be an entity on the network, may be an independent device, or may correspond to a part of functions of another network entity.

The aggregated slot management device may preconfigure an aggregated slot. For example, positions of aggregated slots of cells managed by the aggregated slot management device may be aligned identically. In addition, an aggregated slot for each cell may include the same operation interval and offset configuration.

According to an embodiment of the disclosure, radio resources to which traffic of a cell is allocated may be aggregated into a preconfigured aggregated slot and scheduled.

The aggregated slot management device 920 may transmit information on an aggregated slot configured for a serving cell 910 and an interfering cell 930 connected to the aggregated slot management device 920 (940). The serving cell 910 may refer to a serving base station that transmits data to a UE, and the interfering cell 930 may refer to a cell of an interfering base station that is adjacent to the serving base station and may cause inter-cell interference in data transmission to the UE by the serving cell.

According to an embodiment of the disclosure, the aggregated slot management device may transmit information on an aggregated slot having the same position for each of multiple cells to the multiple cells managed by the aggregated slot management device.

The serving cell 910 may aggregate and allocate traffic to be transmitted in a predetermined interval to the aggregated slot, based on the information on the aggregated slot received from the aggregated slot management device 920 (945). When the traffic allocated to the aggregated slot exceeds an allocated radio resource, the serving cell may allocate excess traffic to the next slot of the aggregated slot. According to an embodiment of the disclosure, even when the next slot of the aggregated slot is a non-aggregated slot, since a large portion of the traffic acting as interference to a radio resource of the serving cell may have already been transmitted in the aggregated slot, the impact of the excess traffic allocated to the non-aggregated slot on the serving cell may be minimized and/or reduced.

According to an embodiment of the disclosure, the serving cell may receive information on an aggregated slot of multiple neighboring cells from the aggregated slot management device. The serving cell may schedule traffic in the same aggregated slot as the aggregated slot of the multiple neighboring cells, based on the information on the aggregated slot of the multiple neighboring cells. In this case, the aggregated slot of the multiple neighboring cells may be an aggregated slot having the same position for each neighboring cell.

Thereafter, the serving cell 910 may determine separate AMC for the aggregated slot and the non-aggregated slot, based on the information on the aggregated slot (950). According to an embodiment of the disclosure, if the past transmission in the aggregated slot is an ACK, an SINR of the aggregated slot may be increased, and if the past transmission in the aggregated slot is a NACK, the SINR may be decreased. If the past transmission in the non-aggregated slot is an ACK, an SINR of the non-aggregated slot may be increased, and if the past transmission in the non-aggregated slot is a NACK, the SINR may be decreased. The SINR may be increased by increasing the strength of a reception signal of an uplink.

An adaptive modulation and coding selection (MCS) level is selected according to a signal SINR ratio of a channel through which data is transmitted and received. A low MCS level is applied to the aggregated slot, and a high MCS level is applied to the non-aggregated slot, so that a low data transmission rate may be applied to the aggregated slot in which the frequency of occurrence of inter-cell interference is expected to be high.

The serving cell 910 may transmit the traffic of the aggregated slot to the UE using the separately determined AMC (955). In this case, the probability of occurrence of inter-cell interference of the traffic transmitted to the UE may be lower than the probability of occurrence of inter-cell interference of traffic when the aggregated slot is not configured.

According to an embodiment of the disclosure, the serving cell may transmit the traffic of the same aggregated slot as the aggregated slot of the multiple neighboring cells to the UE. In this case, the aggregated slot of the multiple neighboring cells may be an aggregated slot having the same position for each neighboring cell.

The interfering cell 930 may aggregate and allocate traffic to be transmitted in a predetermined interval to the aggregated slot, based on the information on the aggregated slot received from the aggregated slot management device 920 (960). The transmission may be delayed (latency) until traffic of a cell that may act as interference arrives at the aggregated slot. Accordingly, the traffic of the cell that may act as interference may be aggregated in the aggregated slot, and the number of slots occupied by the traffic of the cell may be reduced compared to the number of slots occupied by the traffic of the cell before the aggregated slot is configured. In other words, the number of slots acting as interference is reduced and thus the total amount of interference is reduced, thereby improving the performance of data transmission.

The interfering cell 930 may transmit, to the UE, traffic of a neighboring cell, that is aggregated in the aggregated slot and acts as interference (965).

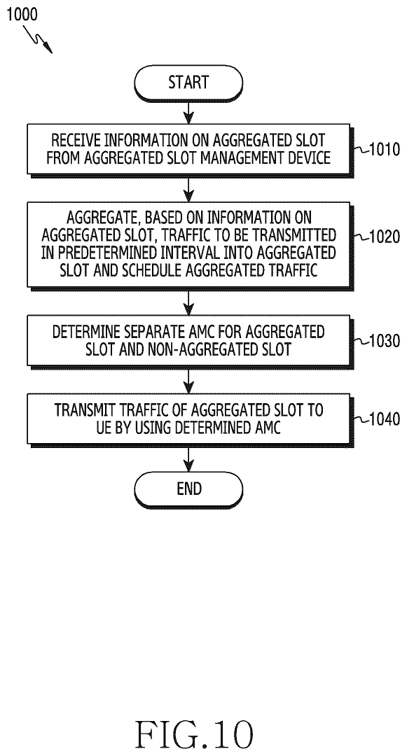

FIG. 10 is a flowchart 1000 illustrating example operations of a serving base station according to various embodiments. The serving cell 910 may refer to a serving base station that transmits data to a UE.

Referring to FIG. 10, in operation 1010, the serving cell may receive information on an aggregated slot from an aggregated slot management device connected to the serving cell. The information on the aggregated slot may include information in which a specific slot of a predetermined interval is configured as a slot for aggregating and allocating traffic of a cell.

In operation 1020, the serving cell may aggregate, based on the information on the aggregated slot, traffic to be transmitted in a predetermined interval into the aggregated slot and schedule the aggregated traffic.

According to an embodiment of the disclosure, when traffic allocated to the aggregated slot exceeds an allocated radio resource, the serving cell may allocate excess traffic to the next slot of the aggregated slot. In this case, even when the next slot of the aggregated slot is a non-aggregated slot, the excess traffic may be allocated.

In operation 1030, the serving cell may determine separate AMC for the aggregated slot and the non-aggregated slot. According to an embodiment of the disclosure, if the past transmission in the aggregated slot is an ACK, an SINR of the aggregated slot may be increased, and if the past transmission in the aggregated slot is a NACK, the SINR may be decreased. If the past transmission in the non-aggregated slot is an ACK, an SINR of the non-aggregated slot may be increased, and if the past transmission in the non-aggregated slot is a NACK, the SINR may be decreased. The SINR may be increased by increasing the strength of a reception signal of an uplink.

For example, a low MCS level is applied to the aggregated slot, and a high MCS level is applied to the non-aggregated slot, so that a low data transmission rate may be applied to the aggregated slot in which the frequency of occurrence of inter-cell interference is expected to be high.

In operation 1040, the serving cell may transmit the traffic of the aggregated slot to a UE using the separately determined AMC. In this case, the probability of occurrence of inter-cell interference of the traffic transmitted to the UE may be lower than the probability of occurrence of inter-cell interference of traffic when the aggregated slot is not configured.

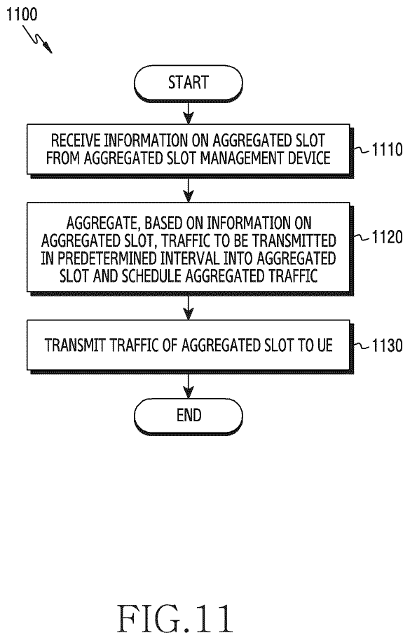

FIG. 11 is a flowchart 1100 illustrating example operations of a neighboring base station according to various embodiments. A neighboring cell may refer to a cell of a neighboring base station that is adjacent to a serving base station and may cause inter-cell interference in data transmission to a UE by the serving cell. The neighboring cell may be referred to as an interfering cell (for example, 930 of FIG. 9).

Referring to FIG. 11, in operation 1110, the neighboring cell may receive information on an aggregated slot from an aggregated slot management device connected to the neighboring cell. The information on the aggregated slot may include information in which a specific slot of a predetermined interval is configured as a slot for aggregating and allocating traffic of a cell.

In operation 1120, the neighboring cell may aggregate, based on the information on the aggregated slot received from the aggregated slot management device, traffic acting as interference to be transmitted in a predetermined interval into the aggregated slot and schedule the aggregated traffic. The transmission may be delayed (latency) until the traffic acting as interference arrives at the aggregated slot. Accordingly, traffic of a neighboring cell that acts as interference may be aggregated into the aggregated slot, and the number of slots occupied by the traffic of the neighboring cell that acts as interference may be reduced compared to the number of slots occupied by the traffic of the neighboring cell that acts as interference when the aggregated slot is not configured.

In operation 1130, the neighboring cell may transmit the traffic of the aggregated slot to the UE.

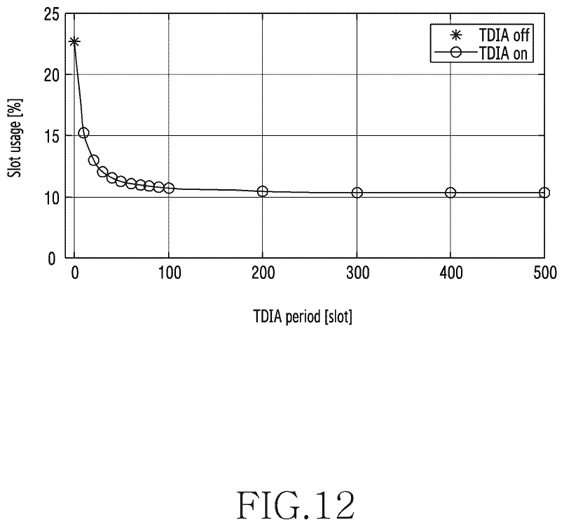

FIG. 12 is a graph illustrating slot usage relative to a period of an aggregated slot according to various embodiments. For example, a result of a simulation based on a traffic pattern collected from a commercial network is illustrated.

Referring to FIG. 12, the horizontal axis may indicate a time domain, and specifically, a period of an aggregated slot configured through a TDIA operation which is an operation of configuring an aggregated slot to control inter-cell interference in the time domain. The vertical axis may indicate a slot usage, and the slot usage may refer to the ratio of slots used to transmit traffic among all slots. When the slot usage is high, there may be a high probability that there is a slot allocated with traffic of a neighboring cell that acts as interference in addition to traffic desired to be transmitted by a serving cell. For example, the slot usage may indicate the possibility of potential inter-cell interference.

In FIG. 12, when traffic is transmitted without configuring an aggregated slot (in the case of TDIA off), the slot usage may indicate a value of 22.7%. This may indicate that the probability of occurrence of potential inter-cell interference is 22.7%. In FIG. 12, when traffic is transmitted by configuring an aggregated slot (in the case of TDIA on), the slot usage may be lower than a value of 22.7% as an operation interval of the aggregated slot increases. For example, when the operation interval of the aggregated slot is configured to be 10 slots, the slot usage may be reduced to 15.2%. This may indicate that the probability of occurrence of potential inter-cell interference has been reduced to 15.2%. For example, if the transmission of the traffic is delayed for up to 10 slots and the traffic is aggregated and allocated, the probability of occurrence of inter-cell interference may be reduced by a total of 33% from 22.7% to 15.2%.

In addition, as the number of slots of the operation interval of the aggregated slot increases, the slot usage may gradually decrease and then converge to a predetermined value. For example, in FIG. 12, when the operation interval of the aggregated slot is configured to be 10 slots, the slot usage is 15.2%, and when the operation interval of the aggregated slot is configured to be 30 slots, the slot usage is 12.0%. As the operation interval of the aggregated slot increases, the slot usage may gradually decrease and then converge to a value of 10.4%.

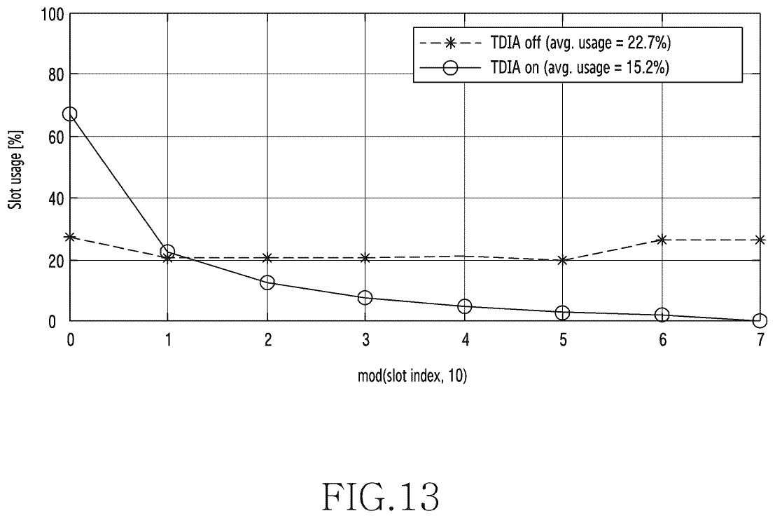

FIG. 13 is a graph illustrating slot usage relative to a period of an aggregated slot according to various embodiments.

Referring to FIG. 13, the horizontal axis indicates a time domain, and specifically, indicates a slot index when an operation interval of an aggregated slot is configured to be 10 slots. The vertical axis may indicate a slot usage, and the slot usage may refer to the ratio of slots used to transmit traffic among all slots. When the slot usage is high, there may be a high probability that there is a slot allocated with traffic of a neighboring cell that acts as interference in addition to traffic desired to be transmitted by a serving cell. For example, the slot usage may indicate the possibility of potential inter-cell interference.

In FIG. 13, when traffic is transmitted without configuring an aggregated slot in a downlink (DL) (in the case of TDIA off), an average value of the slot usage may indicate a value of 22.7%. When an aggregated slot is configured and traffic is transmitted (in the case of TDIA on), the average value of the slot usage may indicate a value of 15.2%. For example, it may be seen that the average value of the slot usage is reduced from 22.7% to 15.2% when the aggregated slot is configured and traffic of a neighboring cell that acts as interference is aggregated and allocated, compared to when the aggregated slot is not configured. This may indicate that the probability of occurrence of potential inter-cell interference has been reduced from 22.7% to 15.2%.

In addition, when examining the pattern of the graph, in the case of transmitting traffic without configuring an aggregated slot, traffic causing interference is evenly distributed in each slot, and thus the slot usage may be evenly distributed across all slots. On the other hand, in the case of transmitting traffic by configuring an aggregated slot, traffic causing interference is aggregated in and around the aggregated slot, and thus the slot usage in the aggregated slot may be high.

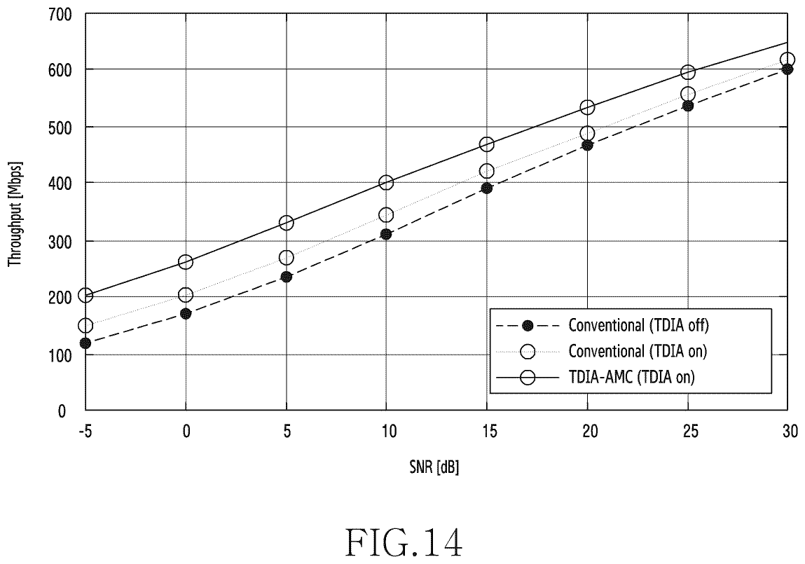

FIG. 14 is a graph illustrating data throughput relative to a signal to noise ratio (SNR) according to various embodiments.

Referring to FIG. 14, the horizontal axis of the graph indicates an SNR, and the vertical axis indicates throughput of DL data. When data is processed without configuring a conventional aggregated slot, the data throughput may be lower in relation to the SNR than when an aggregated slot is configured and data is processed.

Additionally, even in the case of transmitting traffic by configuring an aggregated slot, the data throughput may be higher in the case of aggregating and allocating traffic to an aggregated slot and determining separate AMC for the aggregated slot and a non-aggregated slot other than the aggregated slot, rather than aggregating and allocating traffic to an aggregated slot.

For example, it may be identified that the case of processing data by aggregating and allocating traffic of a neighboring cell that acts as interference to an aggregated slot shows higher data throughput than the case of processing data without configuring the aggregated slot. This may indicate that the case of configuring the aggregated slot may improve the performance of data processing. For example, in FIG. 14, when an aggregated slot is configured and separate AMC is determined for the aggregated slot and a non-aggregated slot (in the case of TDIA on), the data throughput is improved by 5 to 36% compared to the data throughput when the aggregated slot is not configured (in the case of TDIA off), and on average, the data throughput may be improved by 17%.

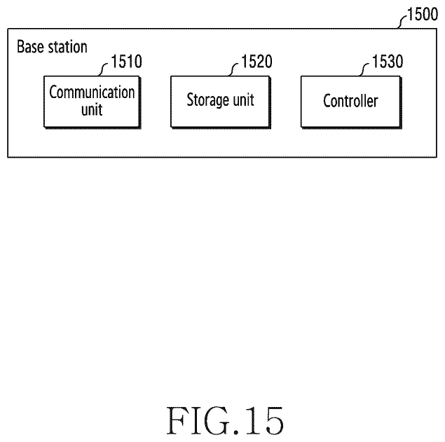

FIG. 15 is a block diagram illustrating an example configuration of a base station according to various embodiments.

Referring to FIG. 15, a base station 1500 includes a communication unit (e.g., including communication circuitry) 1510, a storage (e.g., a memory) 1520, and a controller (e.g., including various processing circuitry) 1530.

The communication unit 1510 may include various communication circuitry and performs functions for transmitting/receiving signals through a radio channel. For example, the communication unit 1510 performs functions of conversion between baseband signals and bitstrings according to the physical layer specifications of the system. For example, during data transmission, the communication unit 1510 encodes and modulates a transmitted bitstring to generate complex symbols. In addition, during data reception, the communication unit 1510 demodulates and decodes a baseband signal to restore a received bitstring. In addition, the wireless communication unit 1510 up-converts a baseband signal to an RF band signal, transmits the same through an antenna, and down-converts an RF band signal received through the antenna to a baseband signal.

To this end, the wireless communication unit 1510 may include a transmission filter, a reception filter, an amplifier, a mixer, an oscillator, a digital to analog converter (DAC), an analog to digital converter (ADC), and the like. In addition, the communication unit 1510 may include multiple transmission/reception paths. Furthermore, the wireless communication unit 1510 may include at least one antenna array including multiple antenna elements. In terms of hardware, the wireless communication unit 1510 may include a digital unit and an analog unit, and the analog unit may include multiple sub-units according to operation power, frequencies, etc.

The communication unit 1510 may transmit/receive signals. To this end, the communication unit 1510 may include at least one transceiver. For example, the communication unit 1510 may transmit a synchronization signal, a reference signal, system information, a message, control information, data, or the like. Furthermore, the communication unit 1510 may perform beamforming.

The communication unit 1510 transmits and receives signals as described above. Accordingly, all or part of the communication unit 1510 may be referred to as a “transmitter”, a “receiver”, or a “transceiver”. In addition, as used in the following description, the meaning of “transmission and reception performed through a radio channel” includes that the above-described processing is performed by the communication unit 1510.

The storage 1520 may include a memory and stores data such as basic programs, application programs, and configuration information for operations of the base station. The storage 1520 may include a memory. The storage 1520 may include a volatile memory, a nonvolatile memory, or a combination of a volatile memory and a nonvolatile memory. In addition, the storage unit 1520 provides the stored data at the request of the controller 1530.

The controller 1530 may include various processing circuitry and controls the overall operation of the base station 1500. For example, the controller 1530 transmits/receives signals through the communication unit 1510. In addition, the controller 1530 records data in the storage 1520 and reads the data from the storage 230. Furthermore, the controller 1530 may perform functions of protocol stacks required by communication specifications. To this end, the controller 1530 may include at least one processor. The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The structure of the base station 1500 illustrated in FIG. 15 is a merely an example of the base station, and examples of the base station for performing various embodiment of the disclosure are not limited to the structure illustrated in FIG. 15. That is, some elements may be added, omitted, or changed according to various embodiments.

In FIG. 15, the base station 1500 has been described as a single entity, but the disclosure is not limited thereto. In addition to the integrated deployment, the base station 1500 according to various embodiments of the disclosure may be implemented to construct an access network having a distributed deployment. According to an embodiment, the base station may be divided into a central unit (CU) and a digital unit (DU), the CU may be implemented to perform upper layer functions (e.g., packet data convergence protocol (PDCP) and RRC), and the DU may be implemented to perform lower layer functions (e.g., medium access control (MAC) and physical (PHY)). The DU of the base station may form beam coverage on a radio channel.

The various example embodiments of the disclosure are merely examples that have been presented to explain the technical contents of the disclosure and aid in understanding of embodiments of the disclosure, and are not intended to limit the scope of the disclosure. For example, it will be apparent to those skilled in the art that other variants based on the technical idea of the disclosure may be implemented. Also, the above respective embodiments may be employed in combination, as necessary.

As described above, according to various example embodiments of the disclosure, a method performed by a serving cell in a wireless communication system may include: receiving information on an aggregated slot from an aggregated slot management device, aggregating, based on the information on the aggregated slot, traffic to be transmitted during a specified interval into the aggregated slot and scheduling the aggregated traffic, determining separate adaptive modulation and coding (AMC) for the aggregated slot and a non-aggregated slot, and transmitting the traffic of the aggregated slot to a terminal using the determined AMC.

According to various example embodiments of the disclosure, the method may include allocating excess traffic to the next slot of the aggregated slot based on traffic allocated to the aggregated slot exceeding an allocated radio resource.

According to various example embodiments of the disclosure, the aggregated slot may be aligned to a same position across all cells of a base station managed by the aggregated slot management device.

According to various example embodiments of the disclosure, the aggregated slot may be repeatedly configured according to a specified period.

According to various example embodiments of the disclosure, the determining of the AMC may further include applying a low modulation coding scheduling (MCS) level to the aggregated slot, and applying a high MCS level to the non-aggregated slot.

As described above, according to various example embodiments of the disclosure, a device of a serving cell in a wireless communication system may include: a transceiver and at least one processor, comprising processing circuitry, wherein at least one processor, individually and/or collectively, is configured to: receive information on an aggregated slot from an aggregated slot management device, aggregate, based on the information on the aggregated slot, traffic to be transmitted during a specified interval into the aggregated slot and schedule the aggregated traffic, determine separate adaptive modulation and coding (AMC) for the aggregated slot and a non-aggregated slot, and control the transceiver to transmit the traffic of the aggregated slot using the determined AMC.

According to various example embodiments of the disclosure, at least one processor, individually and/or collectively, may be configured to allocate excess traffic to the next slot of the aggregated slot based on traffic allocated to the aggregated slot exceeding an allocated radio resource.

According to various example embodiments of the disclosure, the aggregated slot may be aligned to the same position across all cells of a base station managed by the aggregated slot management device.

According to various example embodiments of the disclosure, the aggregated slot may be repeatedly configured according to a specified period.

According to various example embodiments of the disclosure, at least one processor, individually and/or collectively, may be configured to apply a low modulation coding scheduling (MCS) level to the aggregated slot, and apply a high MCS level to the non-aggregated slot.

As described above, according to various example embodiments of the disclosure, a method performed by an interfering cell in a wireless communication system may include: receiving information on an aggregated slot from an aggregated slot management device, aggregating, based on the information on the aggregated slot, traffic to be transmitted during a specified interval into the aggregated slot and scheduling the aggregated traffic, and transmitting the traffic in the aggregated slot.

According to various example embodiments of the disclosure, the aggregating of the traffic into the aggregated slot and allocating of the aggregated traffic may include waiting until the traffic is allocated to the most neighboring aggregated slot among slots after a slot in which the traffic has occurred.

According to various example embodiments of the disclosure, the aggregated slot may be aligned to a same position across all cells of a base station managed by the aggregated slot management device.

According to various example embodiments of the disclosure, the aggregated slot may be repeatedly configured according to a specified period.

As described above, according to various example embodiments of the disclosure, a device of an interfering cell in a wireless communication system may include: a transceiver and at least one processor, comprising processing circuitry, wherein at least one processor, individually and/or collectively, is configured to: receive information on an aggregated slot from an aggregated slot management device, aggregate, based on the information on the aggregated slot, traffic to be transmitted during a specified interval into the aggregated slot and schedule the aggregated traffic, and control the transceiver to transmit the traffic in the aggregated slot.

According to various example embodiments of the disclosure, at least one processor, individually and/or collectively, may be configured to aggregate and allocate the traffic to the aggregated slot, and wait until the traffic is allocated to the most neighboring aggregated slot among slots after a slot in which the traffic has arrived.

According to various example embodiments of the disclosure, the aggregated slot may be aligned to a same position across all cells of a base station managed by the aggregated slot management device.

According to various example embodiments of the disclosure, the aggregated slot may be repeatedly configured according to a specified period.

What is claimed is:

1. A method performed by a serving base station in a wireless communication system, the method comprising:
receiving information on an aggregated slot from an aggregated slot management device;
scheduling, based on the information on the aggregated slot, traffic by aggregating the traffic to be transmitted during a predetermined interval into the aggregated slot;
determining separate adaptive modulation and coding (AMC) for the aggregated slot and a non-aggregated slot; and
transmitting the traffic of the aggregated slot to a terminal using the determined AMC.

2. The method of claim 1, wherein the method comprises, based on traffic allocated to the aggregated slot exceeding an allocated radio resource, allocating excess traffic to a next slot of the aggregated slot.

3. The method of claim 1, wherein the aggregated slot is aligned to a same position across all cells of a base station managed by the aggregated slot management device and is repeatedly configured according to a preconfigured period.

4. The method of claim 1, wherein the determining of the AMC further comprises:
applying a low modulation coding scheduling (MCS) level to the aggregated slot; and
applying a high MCS level to the non-aggregated slot.

5. A device of a serving base station in a wireless communication system, the device comprising:
a transceiver; and
at least one processor,
wherein the at least one processor is configured to:
receive information on an aggregated slot from an aggregated slot management device;
schedule, based on the information on the aggregated slot, traffic by aggregating the traffic to be transmitted during a predetermined interval into the aggregated slot and schedule the aggregated traffic;
determine separate adaptive modulation and coding (AMC) for the aggregated slot and a non-aggregated slot; and
transmit the traffic of the aggregated slot to a terminal using the determined AMC.

6. The device of claim 5, wherein the at least one processor is configured to: based on traffic allocated to the aggregated slot exceeding an allocated radio resource, allocate excess traffic to a next slot of the aggregated slot.

7. The device of claim 5, wherein the aggregated slot is aligned to a same position across all cells of a base station managed by the aggregated slot management device and is repeatedly configured according to a preconfigured period.

8. The device of claim 5, wherein the at least one processor is configured to:
apply a low modulation coding scheduling (MCS) level to the aggregated slot; and
apply a high MCS level to the non-aggregated slot.

9. A method performed by a neighboring base station in a wireless communication system, the method comprising:
receiving information on an aggregated slot from an aggregated slot management device;
aggregating, based on the information on the aggregated slot, traffic to be transmitted during a predetermined interval into the aggregated slot and scheduling the aggregated traffic; and
transmitting the traffic of the aggregated slot to a terminal.

10. The method of claim 9, wherein the aggregating of the traffic into the aggregated slot and scheduling of the aggregated traffic comprises waiting until the traffic is scheduled to a most neighboring aggregated slot among slots after a slot in which the traffic has occurred.

11. The method of claim 9, wherein the aggregated slot is aligned to a same position across all cells of a base station managed by the aggregated slot management device.

12. The method of claim 9, wherein the aggregated slot is repeatedly configured according to a preconfigured period.

13. A device of a neighboring base station in a wireless communication system, the device comprising:
a transceiver; and
at least one processor,
wherein the at least one processor is configured to:
receive information on an aggregated slot from an aggregated slot management device;
aggregate, based on the information on the aggregated slot, traffic to be transmitted during a predetermined interval into the aggregated slot and schedule the aggregated traffic; and
transmit the traffic of the aggregated slot to a terminal.

14. The device of claim 13, wherein the at least one processor is configured to:
aggregate the traffic into the aggregated slot and schedule the aggregated traffic; and
wait until the traffic is allocated to a most neighboring aggregated slot among slots after a slot in which the traffic has occurred.

15. The device of claim 13, wherein the aggregated slot is aligned to a same position across all cells of a base station managed by the aggregated slot management device and is repeatedly configured according to a preconfigured period.
